(19) United States
(12) Patent Application Publication
(10) Pub. No.: US 2021/0044450 A1
(43) Pub. Date: Feb. 11, 2021

(54) METHOD AND SYSTEM FOR PERFORMING DOUBLE MESSAGE ARBITRATION

(71) Applicant: YAMAR ELECTRONICS LTD., TEL-AVIV (IL)

(72) Inventors: YAIR MARYANKA, TEL-AVIV (IL); ERAN PRIEL, TEL-AVIV (IL)

(21) Appl. No.: 16/990,104

(22) Filed: Aug. 11, 2020

(30) Foreign Application Priority Data
Aug. 11, 2019 (EP) 19191153

(51) Int. Cl. H04L 12/40; H04L 29/06; H04L 1/00; H04L 12/801

(52) U.S. Cl. CPC H04L 12/40032; H04L 69/18; H04L 2012/40215; H04L 47/12; H04L 1/0056

(57) ABSTRACT

A data system is adapted to communicate for message arbitration in a first communication network based on physical arbitration of a second communication network. The first network includes a plurality of first nodes interconnected with corresponding second nodes of the second network. A message is received from a first node at a corresponding second node, the message including arbitration data of the first network. Based on the received message, data generating a message-frame at the second node follows. The message-frame includes a start preamble including a modified arbitration sequence of the first communication network and (upon successful arbitration) subsequently transmitting the message-frame over the second network is provided. The method ensures arbitration on one medium i.e. network when the original message arbitration is performed on a different, second medium. The networks or media are wired or wireless. Both technologies can benefit from the methodology.

### CROSS-REFERENCE TO RELATED APPLICATION

This application claims the priority, under 35 U.S.C. § 119, of European Patent Application EP 19191153, filed Aug. 11, 2019; the prior application is herewith incorporated by reference in its entirety.

### BACKGROUND OF THE INVENTION

### Field of the Invention

The present invention relates to a method and system for performing message arbitration, especially double message arbitration in a first communication network based on arbitration information of a second communication network.

### Description of the Related Art

Generally, vehicles, airplanes and the like employ many sensors, actuators, controllers, sub-systems, buses, etc. that require appropriate controlling of the communication between interconnected nodes or devices. As the number of the communication channels and/or protocols within the vehicles increases so does the methodology of supporting the controlling of those systems.

For instance, modern cars comprise a plurality of electronic control devices for various subsystems. Typically, the biggest processor is the engine control unit. Others are used for transmission, airbags, audio systems, power windows, doors, mirror adjustment etc. Some of these form independent subsystems or communication channel, but inter-communications among other systems may be essential for the security, reliability and/or convenience of a modern car. To cope with this, various communication protocols were introduced; some of which employ arbitration to allow random access of control devices to the network. CAN standard is an example to one possible bus system, but other communication protocols can also be used in parallel.

Therefore, if the systems comprise a plurality of devices interconnected to communicate over different protocols there is a need in ensuring a proper arbitration of the message flow within the network.

### BRIEF SUMMARY OF THE INVENTION

It is accordingly an object of the invention to provide a method and a system for performing double message arbitration, which overcome the hereinafore-mentioned disadvantages of the heretofore-known methods and systems of this general type and which provide cross-border secure and reliable data communication over different data networks or sub-systems.

With the foregoing and other objects in view there is provided, in accordance with the invention, a method for performing message arbitration in a first communication network on the basis of physical arbitration of a second communication network is provided. The first communication network comprises a plurality of first nodes which are in turn interconnected with corresponding second nodes of the second communication network.

The method according to the present invention comprises in a first step receiving a message from a first node at a corresponding second node, wherein the message comprises physical arbitration data of the first communication network. Based on the received message data generating a message-frame at the second node follows. The message-frame includes a start preamble comprising a modified arbitration sequence of the first communication network and subsequently transmitting of the message-frame over the second communication network is provided.

According to the present invention, a modified arbitration sequence can be a bit-wise replacement of the first arbitration sequence with a phase\frequency sequence that is adapted to the second network. Therefore, a cross-border arbitration, that is a double arbitration, over different kind of networks can be achieved.

Therefore, the method according to the present invention ensures arbitration on one medium i.e. network when the original message arbitration is performed on a different, second medium. According to the present invention, the aforementioned networks or media can be wire based (wired) or wireless (over air, optical or the like). Both techniques may profit from the methodology according to the present invention.

Furthermore, advantageously if for instance a first communication network is to be implemented there is no need to implement a first physical network because the method of the present invention allows emulation of the first communication over the already existing infrastructure associated with the second communication network. Therefore, material costs like wires or the like are unnecessary.

With the objects of the invention in view, there is also provided a protocol-based data transmission system. The system comprises a plurality of first nodes and a plurality of second nodes, wherein the first nodes are required to communicate by using a second communication network and the second nodes being adapted to communicate according to the aforementioned method.

Thus, a system for data communication is provided, which allows interconnection of devices within different used communication networks. Advantageously the arbitration technology of a first network can be used to ensure controlled data communication within the second network as well.

According to an embodiment of the present invention the generated message-frame further comprises at least one data set, error correction code information and a message suffix. Hence, a secure and reliable data communication between pluralities of nodes is ensured.

The second node is adapted to detect data transmission in the second communication network and in turn to inform the corresponding first node to suspend message sending. Through the use of such mechanism bus congestion for instance over physical lines may be omitted. This is very advantageous if plurality of nodes or devices share the same communication line.

According to an embodiment the second node sends a reserved message of the corresponding first node after detecting data transmission in the second communication network, the reserved message causing losing arbitration procedure of the first node within the first communication network. Consequently, the present invention allows additionally also a local arbitration between the concerned controller and its counterpart device interconnecting the second data communication network.

The detected data transmission may correspond to data traffic within the second communication network and/or data traffic of the corresponding node within the first data communication network. Hence, cross boarder data arbitration between different networks and/or local communication between corresponding devices can be achieved.

According to an embodiment the method according to the present invention further comprises detecting a network contention of the second data communication network and sending the reserved message to the corresponding first node. Accordingly, the method ensures that the first nodes to be used is always in idle mode if an involved second node intents to release a message over the second nodes or communication channel.

It is conceivable that the second data communication network is a wired communication channel or a wireless communication channel. Thus, different kinds of data communication networks can be arbitrated by using the method of the present invention.

According to embodiment of the second aspect of the present invention the second nodes comprises a communication interface to communicate with the corresponding first node using first network protocol. This allow proper interconnection between involved communication nodes.

The second nodes comprises a first communication interface to communicate with the corresponding first node using a first-network protocol, and second communication interface to communicate over a second communication network and/or a wireless network using a second-network protocol. Therefore, the second devices may act as a communication bridge to interconnect different types of data communication networks.

The accompanying figures are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description.

Although the invention is illustrated and described herein as embodied in a method and a system for performing double message arbitration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram showing the principle of the present invention for a CAN bus as an example;

FIG. 2 is a block diagram of a communication network in a vehicle according to the present invention;

FIG. 3 is a block diagram showing an implementation a DCAN device according to an embodiment of the present invention;

FIG. 4 is a side-elevational view illustrating the structure of a CAN-frame according to an embodiment of the present invention;

FIG. 5 is a timing diagram for two connected devices according to the present invention;

FIG. 6 is a diagram showing the timing behavior during transmission of a message according to an embodiment of the present invention; and

FIG. 7 is a diagram showing the timing behavior during receiving of a message according to an embodiment of the present invention.

### DETAILED DESCRIPTION OF THE INVENTION

In the following reference is made to the accompanying drawings, which form a part hereof, and in which is shown by way of illustration specific embodiments in which the invention may be practiced. In this regard, directional terminology, such as “top,” “bottom,” “front,” “back,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

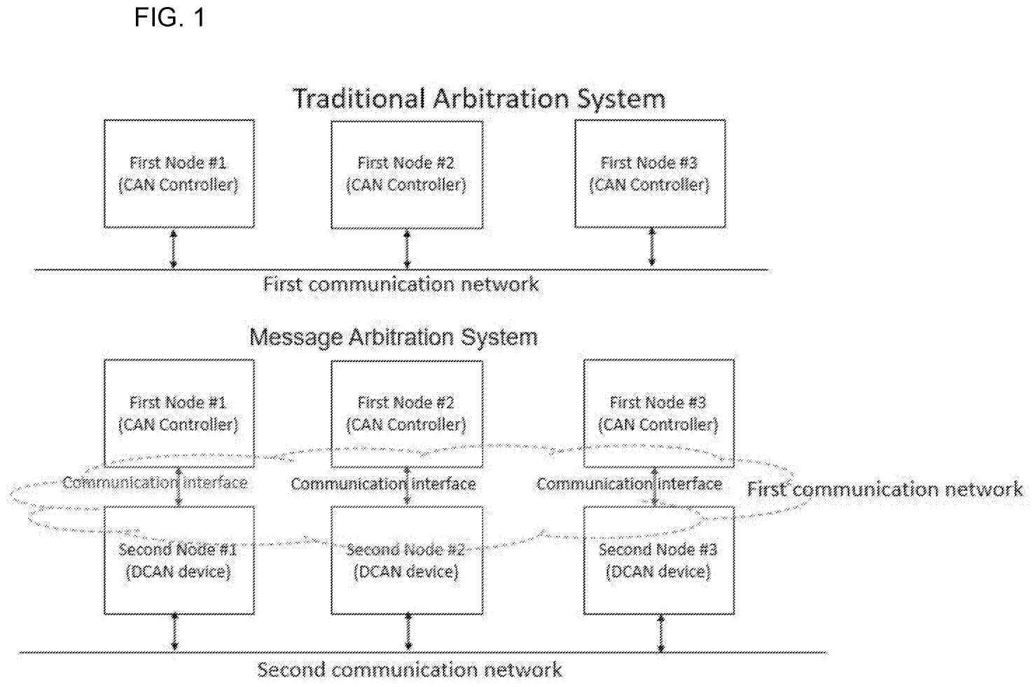

Referring now to the figures of the drawings in detail and first, particularly, to FIG. 1 thereof, there is seen an illustration of the principle of the present invention wherein two different communication networks with their corresponding interconnection nodes are schematically shown. According to the present invention a method for message arbitration on one medium when the original message arbitration is performed on a different medium is provided. According to a possible embodiment both media (communication networks) are wire based but also other networks like for instance wireless or hybrids are conceivable which may benefit of the methodology of the present invention.

In FIG. 1 the interconnection of two different communication networks is schematically shown. According to an example the first communication network may be a CAN bus and the second communication network a power line (PL) network. Other constellation of networks are imaginable within the scope of the invention.

According to one embodiment, the second communication network is the physically existing network and the first communication network with its first nodes uses the second network to communicate. Within the first communication network a CAN arbitration procedure may be implemented whereby the arbitration data is used for the message arbitration on the second network. Thus, the system working according to the method of the present invention benefits over the traditional arbitration data, for instance CAN arbitration, on the second communication network.

Therefore, for instance, a CAN network is built on a second physical network (PL) whereby the message arbitration on the second network is based on arbitration procedures of the first network. Additionally, no dedicated first network hardware is necessary because the wires of the PL network according to one possible implementation can be used.

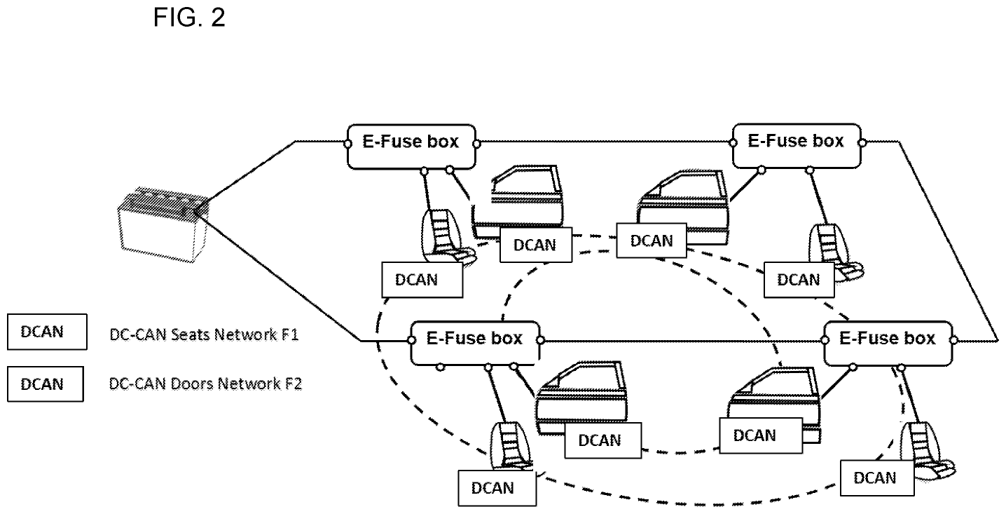

FIG. 2 depicts an embodiment of the present invention as a use case in a vehicle. Two independent CAN communication networks are implemented as an example. The first one for carrying CAN traffic belonging to the vehicle doors, and the second one for carrying CAN traffic of vehicle seats. No dedicated CAN lines are used. Instead, all traffic is converted from CAN protocol to power line (PL) protocol using DCAN devices, when transmitting, and from power line protocol back to CAN protocol when receiving. The doors network traffic is communicated over the power line using a first dedicated carrier frequency, while the seats network employs a second dedicated frequency. Therefore, two virtual CAN networks are formed, whereby the dedicated PL in the vehicle for data transmission is used by omitting usage of dedicated CAN bus copper wires.

In this example only two networks are shown but the present invention may be implemented for several concurrent CAN networks. Additionally, the PL protocol can be replaced by a wireless protocol for instance. This makes the method of the present invention flexible and adaptable for all kinds of imaginable networks.

To ensure a proper interconnection between the paired devices in the communication system a suitable message arbitration according to the invention is implemented.

On the CAN bus or network respectively a bit-wise arbitration can be used. According to the method of the invention the CAN-based arbitration is transferred from the CAN network to the PL network. Therefore, a second arbitration procedure on the second data network is needed. According to the invention the arbitration data or sequences, respectively are used for the arbitration of messages in the second communication network. The DCAN device transforms or translates the CAN messages to corresponding data structures which can be conveyed over the PL network for instance. The arbitration sequence of the first network is therefore used for arbitration on the PL network, that is the second network.

Thus, the present invention ensures double arbitration between DCAN device and its CAN counterpart controller and between DCAN device and other DCAN devices over the PL network. All major network topologies and their modification can be implemented in light of the present invention including, but not limited to: star, ring, line and tree. Multiple DCAN device networks can operate over single power line, whereas each network communicates over different carrier frequency (a.k.a. channel). To this end, DCAN devices provide a seamless interface, providing complete support for the CAN arbitration process, simultaneously with arbitration on the power line physical medium, that is the PL network.

According to this embodiment the present invention ensures proper arbitration in a communication network consisting of at least two CAN controllers that are can send data traffic over a physical power line, rather than over dedicated copper CAN lines. Thus, material costs for setting up a dedicated CAN bus can be omitted.

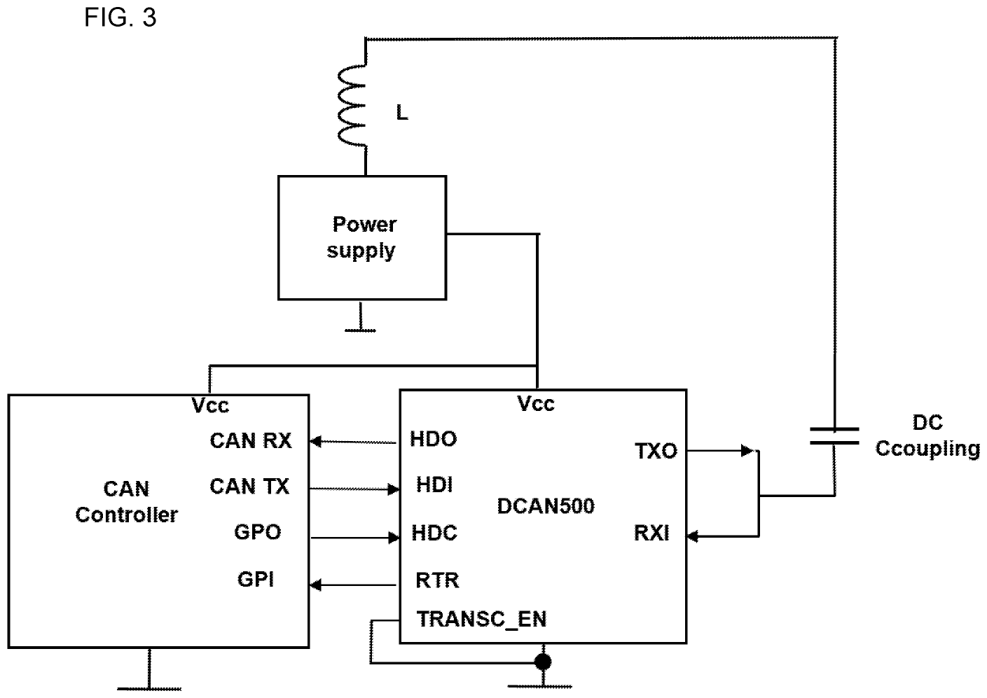

With reference to FIG. 3, each CAN controller connects to a DCAN device that is adapted to convert the CAN protocol-compliant traffic to power line protocol-compliant traffic. As already mentioned, the CAN and the PL protocols are used only as possible embodiment. The number of DCAN nodes on the PL network equals the number of CAN nodes, the invention can be implemented wherein a single DCAN device connects to a CAN network consisting of more than one CAN controller. In this case the DCAN device can communicate with a plurality of CAN controllers or nodes in parallel. This may be cost effective, as less hardware within the network has to be used,

The CAN controllers within the dedicated CAN network must adhere to the CAN protocol. That means that standard-defined parameters such as: bit-rate and timing requirements, voltage levels, number of physical lines, message structure and bus arbitration procedures are fixed. In turn the DCAN devices according to the present invention must adhere to the CAN protocol as well as to the corresponding power line PL protocol. Namely, when interfacing one protocol to another, the DCAN—as the interfacing devices—must exhibit CAN-compliant behavior on the CAN side of the network, and power line-compliant behavior on the power line side of the network. The flexibility of the DCAN device according to an embodiment of the present invention is exemplary shown in the implementation with reference to FIG. 2 above.

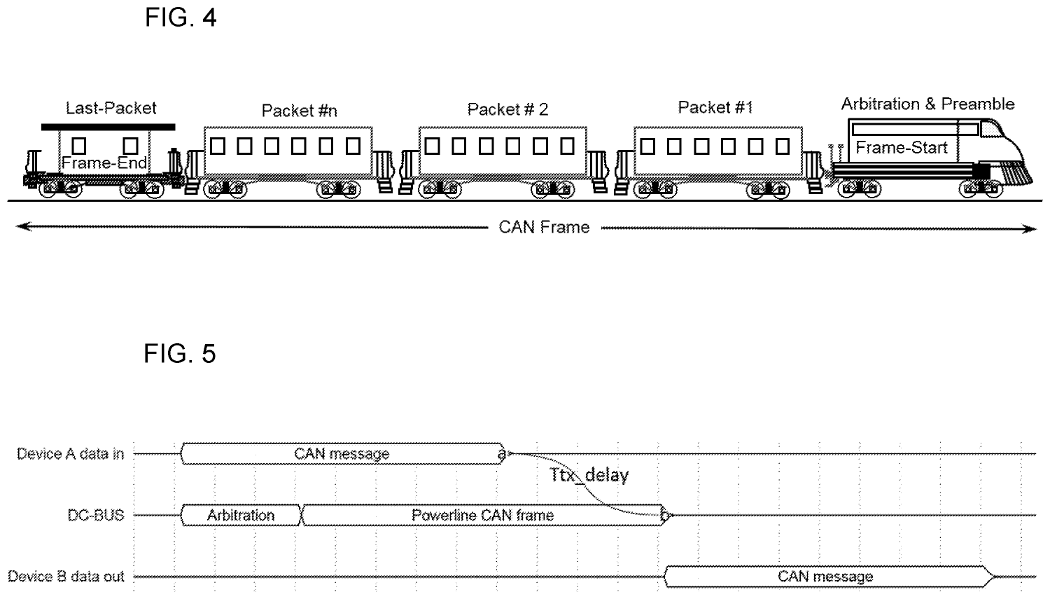

FIG. 4 schematically explains the message structure according to the present invention. Each CAN message (termed CAN message) that is generated by a CAN controller is converted into a single DCAN frame (termed PL-Frame) for transmission over the physical power line. With reference to FIG. 4, a FL-Frame carries CAN messages. The PL-frame over the power line consists of a Frame-Start, in turn consisting of arbitration and preamble patterns, followed by at least one data packet, and terminated with a Frame-End, indicating the last packet of the frame. A data packet can carry any number of bytes, but can also be null, i.e. carry no information at all. An Error Correction Code (ECC) protects each data packet. As depicted in FIG. 4 the PL-Frame can include more bits than a CAN message and can be at a different bitrate. The DCAN device has an automatic provision, termed ‘DUMMY-MSG’, to prevent bus contention.

Because all devices can send data over the same physical line and no master device is present a proper arbitration procedure has to be implemented. In this embodiment for instance line arbitration is conceivable. The arbitration is intended to resolve a conflict when two or more network nodes wish to transmit information on a common communication line simultaneously. Assuming that two, or more, nodes try to access the line simultaneously, the node with the smallest (lowest) identification (ID) number, will get access to the line and be permitted to send its information on the line—this node will be referred to as the “arbitration-winner”. One arbitration process can be found with reference to a well-known CAN protocol standard, wherein the bit-wise arbitration is disclosed.

Generally CAN is a “carrier sense” multiple access protocol, which means that each node observes the bus before transmitting data on it, and if it detects that there is some data on the bus it does not transmit its own data and waits for some predefined time and then tries again. This ensures no corrupting an ongoing transfer on the bus. But there may be a condition when two nodes start transmitting at exact same time. Thus, CAN protocols embodies collision detection and bit wise arbitration.

Data is transmitted by nodes on the bus in form of frames which are schematically shown with reference to FIGS. 4 and 5 of the present description. The PL frame has multiple fields but for arbitration only SOF (Start of Frame) and the identifier ID is of interest (not shown in FIGS. 4 and 5). SOF is a pattern adapted to signal start of a frame to all other nodes on the bus. The subsequent field within the PL frame is the ID which prioritize the message. The lower the identifier, the higher is the priority of the message.

Assuming that two nodes start transmitting at same time both will transmit SOF bit at same time and next the nodes will start transmission of the ID. In this example the ID comprise 11 bits but other lengths may be implemented or used depending on the protocol.

Each node transmits one after the other bits of the ID and compares it with the received bit from the other transmitting party. When a node detects that the “1” bit it transmitted and the bit it sensed back is “0” it knows that a higher priority message is being transmitted on the bus and it starts listening and stops transmitting. This arbitration mechanism thus ensures that no data corruption on the bus may occur.

With reference to FIG. 5 the arbitration procedure according to the present invention is shown, wherein DCAN Device A wins the arbitration and DCAN Device B receives the message from the corresponding device.

In the following the transmit flow according to the present invention is described. Upon receiving a CAN message from its CAN controller, the DCAN device A generates Start-frame pattern that is transmitted over the power line, as schematically shown in FIG. 5. The Start-frame consists of unique power line arbitration based on the controller's CAN message ID in accordance with one possible embodiment.

When a DCAN node within the network wins the arbitration over the power line (that is the second communication network), the DCAN device A wins the arbitration in this example, and following it will respond to the controller with an ACK message at the designated CAN ACK-slot, and transmit a PL frame to all attached DCAN nodes over the power line, that is the DCAN Device B according to the exemplary implementation.

For instance, if a DCAN node (device) loses the arbitration over the power line due to the transmission of another DCAN device (not shown in FIG. 4), it will generate a NACK message that will be sent to the corresponding CAN controller at the designated ACK-slot and the DCAN device will abort the transmission, receive the PL-Frame (send by the winning DCAN device A) from the power line and transfer it to the corresponding CAN controller B. Therefore, the CAN controller, whose corresponding DCAN device lost arbitration, may determine whether to re-transmit the CAN message or discard it.

Each CAN controller is connected to its corresponding DCAN device (see FIG. 2 and FIG. 3), and therefore it has no knowledge if there is ongoing traffic on the power line. The DCAN devices, on the other hand, are connected to the power line, and therefore know if the power line is busy (traffic is ongoing). Hence, if a specific CAN controller wishes to transmit a CAN message when the power line is busy, it is up to the corresponding DCAN device to “inform” this CAN controller that it cannot send any data at this time. This can only be achieved while adhering to the CAN protocol according to the present invention.

This is realized accordingly by making the CAN controller believe that it lost arbitration over the CAN bus, that is a lost arbitration state is emulated. For this purpose, a DUMMY-MSG is defined which is an empty, or “zero” CAN message, whose ID=0 (according to the CAN specification the CAN massage ID=0 is preserved). For the arbitration procedure, such a message will always win the local CAN arbitration with its CAN controller, imposing an artificial delay in the CAN controller TX flow.

According to an embodiment there are at least two other possibilities wherein the reserved DUMMY-MSG is generated.

Firstly, (case 1) if it is detected that the CAN controller initiates a new CAN message transfer while previous CAN message is still being transmitted over the power line (busy PL). In this case, the DUMMY-MSG will make the CAN controller lose arbitration over the CAN bus, and it will have to wait for the duration of the DUMMY-MSG and become a receiver node. Therefore, bus congestions can be avoided as no transmission will occur until the PL bus is in an idle mode.

Secondly (case 2) when the CAN controller initiates a new CAN message while the corresponding DCAN device is in the process of PL frame reception from the power line; in this case, the DCAN-generated DUMMY-MSG, will make the corresponding CAN controller wait until completion of power line PL Frame reception.

Thus, the DCAN node according to the invention will always generate DUMMY-MSGs for as long as the power line is not idle and while the CAN controller tries to initiate a new CAN message transfer.

In the following a receive flow (RX flow) for messages according to the invention is described. Upon detecting a power line PL-Frame, the DCAN device will convert the PL-frame into a CAN message, and then send it to the corresponding CAN controller over the local CAN bus (local link), see FIG. 3, especially CAN RX input of the local CAN node.

A CAN controller—DCAN device conflict can occur when in an event where the CAN controller begins transferring CAN message to the corresponding DCAN device while the DCAN device simultaneously begins transferring its received power line PL-Frame to the the CAN controller. According to the teachings of the present invention there is provided a method for resolving such conflict by initiating a local CAN-bus arbitration process between the CAN controller and the corresponding DCAN device. If the CAN controller wins the local arbitration, the DCAN device will stop its transfer of the power line PL-Frame and receive the controller's CAN message for later transmission over the power line. Then, the DCAN will automatically transfer that power line CAN message to the corresponding CAN controller.

When the CAN controller loses the local CAN-bus arbitration to the DCAN device, the power line PL-Frame will be fully transferred to the CAN controller. Then, CAN controller may transfer that CAN message or it can be discarded according to a possible implementation.

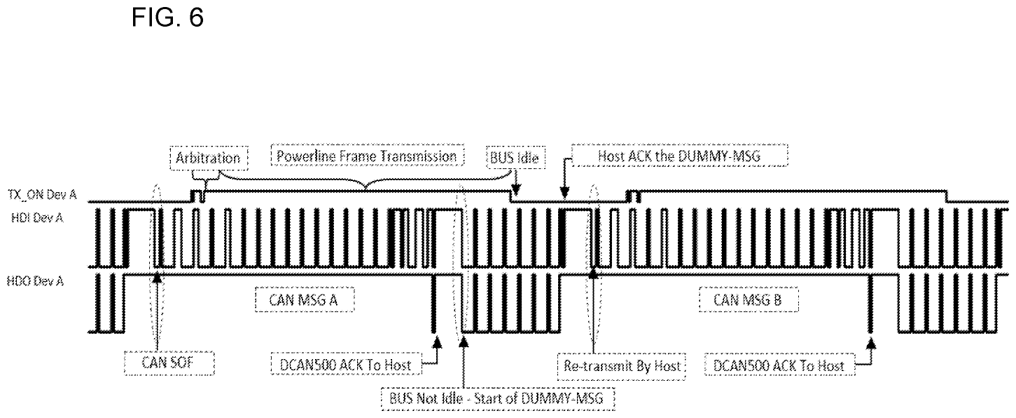

With reference to FIGS. 6 (and 7) the message handling (transmission TX and reception RX flows) of the method according to the present invention is schematically depicted.

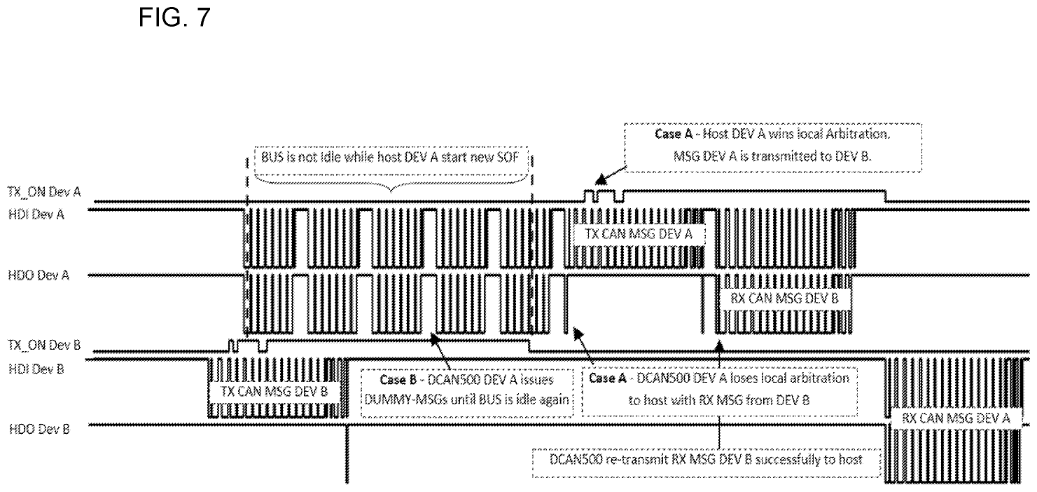

FIG. 7 illustrates how the corresponding CAN controller transmits consecutive CAN messages according to one possible implementation. By way of example, a CAN protocol that defines 3-bit minimal time between two consecutive transmissions is assumed.

Since the power line PL-Frame (FIG. 3) may be longer than a CAN controller's message, the CAN controller must wait until the power line is available to avoid timing hazards. In this example, Example 1, the DCAN device issues a DUMMY-MSG (empty message) to its CAN controller to delay the transfer of a new message until completion of the ongoing CAN power line transmission. Example 1—FIG. 6 depicts two CAN messages A and B with a delay of less than 400 μs. Although CAN message A is still transmitted over the power line, the CAN controller initiates a new message B. Upon detection of the start-of-frame (SOF) of the new message B, the DCAN immediately initiates a DUMMY-MSG. When the transmission of message A is completed over the power line, the power line is available again and the CAN controller re-transmits the CAN message B by the DCAN over the power line.

Example 2—CAN controller generates new SOF while the corresponding DCAN device is in the process of receiving powerline PL-frame from another DCAN node.

FIG. 7 explains exemplary how the corresponding CAN controller A generates new SOF while its DCAN device is receiving power line PL-frame from another DCAN node B.

For the sake of clarity this example can be divided into two sub-scenarios. Case A—Powerline PL-frame was fully decoded and is ready to be transferred to controller. In this case, the DCAN start transferring the power line PL-Frame to the CAN controller. If the controller starts at the same time transferring its own CAN message, a local arbitration will take place between the DCAN and the controller (same as performed in CAN-BUS see above). The message with the higher ID priority will win.

In case the DCAN loses the local arbitration, it will receive the CAN message from its CAN controller, and then it will, transmit the controller CAN message over the power line. Then, the DCAN will retransmit its waiting power line PL-Frame to the corresponding controller again.

Case B—Powerline PL-frame is detected but not fully decoded by DCAN device before corresponding CAN controller A new SOF.

In this case the DCAN has detected a new power line PL-Frame from DCAN B prior to start of a new CAN message from the CAN controller A. Thus, the DCAN A issues a DUMMY-MSG until the power line is idle again. The CAN controller A loses the local arbitration and becomes a receiver. The DCAN A repeats to issue DUMMY-MSG as long as the power line is not idle. Thus, avoiding possible bus conflicts.

The sequence starts when CAN message B is transmitted to the DCAN B node while the power line is idle. After a while, CAN controller A tries to transmit its CAN message A. Due to the fact the DCAN A is already in the process of detecting DCAN B's power line PL-Frame, it will issue DUMMY-MSG to CAN controller A until the power line is idle again.

When DCAN device A is done with receiving DCAN device B PL frame, the DCAN DEV A will start local arbitration with its corresponding controller (CAN controller A). If CAN controller A wins local arbitration, its CAN message is sent over the power line. Then, DCAN device A re-transmit DEV B MSG to its controller successfully. Controller DEV B receives successfully DEV A CAN MSG.

The described DCAN devices making use of the methodology of the present invention can be implemented as a FPGA semiconductor with hard logic programming, as a Digital Signal processor (DSP), or otherwise in application-specific (ASIC) semiconductor or the like.

Therefore, message arbitration within different data communication networks is ensured, wherein arbitration on one data network is performed on arbitration data stemming from the first communication network.

It is to be noticed that the term “comprising,” used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features.

Thus, the scope of the expression “a device comprising means A and B” should not be limited to devices or modules consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Although specific embodiments have been illustrated and described herein, it will be appreciated by those of ordinary skill in the art that a variety of alternate and/or equivalent implementations may be substituted for the specific embodiments illustrated and described without departing from the scope of the present invention. This application is intended to cover any adaptations or variations of the specific embodiments discussed herein. Therefore, it is intended that this invention be limited only by the claims and the equivalents thereof.

According to the present invention a data system is provided adapted to communicate according to a method for performing message arbitration in a first communication network on the basis of physical arbitration of a second communication network. The first communication network comprises a plurality of first nodes which are in turn interconnected with corresponding second nodes of the second communication network.

The method according to the present invention comprises in a first step receiving a message from a first node at a corresponding second node, wherein the message comprises arbitration data of the first communication network. Based on the received message data generating a message-frame at the second node follows. The message-frame includes a start preamble comprising a modified arbitration sequence of the first communication network and (upon successful arbitration) subsequently transmitting of the message-frame over the second communication network is provided.

Therefore, the method according to the present invention ensures arbitration on one medium i.e. network when the original message arbitration is performed on a different, second medium. According to the present invention, the aforementioned networks or media can be wire based or wireless. Both technologies can benefit from the methodology according to the present invention.

1. A method for performing message arbitration in a first communication network based on physical arbitration of a physically existing second communication network, the first communication network including a plurality of first nodes in turn interconnected with corresponding second nodes of the second communication network, the method comprising:
receiving a message from a first node at a corresponding second node, the message including arbitration data of the first communication network;
generating a message-frame at the second node, the message-frame having a start preamble including a modified arbitration sequence of the first communication network; and
transmitting the message-frame over the second communication network by using the corresponding second node.

2. The method according to claim 1, wherein the generated message-frame further includes at least one data set, error correction code information and a message suffix.

3. The method according to claim 1, which further comprises adapting the second node to detect data transmission in the second communication network and in turn to inform the corresponding first node to suspend message sending.

4. The method according to claim 3, which further comprises using the second node to send a reserved message to the corresponding first node after detecting data transmission in the second communication network, the reserved message causing a losing arbitration procedure of the first node within the first communication network.

5. The method according to claim 3, wherein the detected-data transmission corresponds to at least one of data traffic within the second communication network or data traffic of the corresponding node within the first data communication network.

6. The method according to claim 4, which further comprises detecting a network contention of the second data communication network and sending the reserved message to the corresponding first node.

7. The method according to claim 1, wherein the second data communication network is a wired communication channel or a wireless communication channel.

8. The method according to claim 1, wherein the first data communication network is a protocol-based controller area network bus network.

9. A protocol-based data transmission system, comprising:
a plurality of first nodes and a plurality of second nodes;
said second nodes being required to communicate by using a second communication network; and
said first nodes and said second nodes being adapted to communicate according to the method of claim 1.

10. The data system according to claim 9, wherein said first nodes include a communication interface to communicate with said corresponding second nodes by using a first network protocol.

11. The data system according to claim 9, wherein said second nodes include a first communication interface to communicate with said corresponding first nodes by using a first-network protocol, and a second communication interface to communicate over at least one of a second communication network or a wireless network by using a second-network protocol.

12. The data system according to claim 9, wherein said first communication interface is a CAN, CAN FD, high speed CAN or remote device management.

13. The data system according to claim 9, wherein said wireless network is a WiFi network, a 5G network or a Bluetooth network.
